(19) United States
(12) Patent Application Publication
(10) Pub. No.: US 2012/0280512 A1
(43) Pub. Date: Nov. 8, 2012

(54) Electric Generator

(76) Inventor: Robert L. Bliven, Arkport, NY (US)

(21) Appl. No.: 13/102,877

(22) Filed: May 6, 2011

(51) Int. Cl. H02K 7/18; H02K 53/00

(52) U.S. Cl. 290/1 A; 74/DIG. 9

(57) ABSTRACT

An electric generator is disclosed. In an example, the electric generator includes a temporary energy source for starting operations. The electric generator also includes a primary circuit to disconnect the temporary energy source after starting operations. The electric generator also includes a secondary circuit including an array, a collector, and a converter, the collector to collect an AC signal from the array and the converter to convert the AC signal into electric power for output by the electric generator.

### BACKGROUND

In a modern society, energy generation is critical. Today we see countries like India and China emerging as economic giants that require more and more raw material for manufacturing, and they will require greater amounts of fossil fuels for their manufacturing sector. We hear reports of how many trillions of barrels of oil there is available in oil fields around our world, but we are not told that half of these reserves are actually unrecoverable oil. Every oil producing country is reporting a reduction in the amount of oil that they are extracting from their wells. Futures markets know that we are running out of easily extractable oil, so oil prices increase drastically whenever there is a problem in oil producing countries. When oil prices increase, gas prices increase to where those prices are now close to four dollars per gallon, and expected to go even higher. The most notable uses of oil for vehicles are gas, diesel, kerosene, motor oil, heating oil and kerosene for dwellings heating.

Natural gas is more plentiful than oil, but there is a big problem involving pipelines and transportation of natural gas. Natural gas is being used in large quantities for production of electric, in addition to domestic need for cooking and heat. It is only a matter of time before natural gas becomes more difficult to extract from the ground in large quantities. At this time drilling companies are working all over the Northeastern United States in an attempt to extract natural gas from Marcellus shale. To extract this natural gas, companies will pump millions of gallons of chemically treated water (fresh water treated with sand and chemicals) into the ground to cause shale fracturing. If any of this chemically treated water seeps into ground aquifers, this tainted water could become unusable as drinking water for whole communities.

We are so desperate to find coal to burn in our power plants, that companies level mountains just to get to seams of coal a mere meter in depth. Newspapers report that the United States has fifty to one hundred years of coal reserves. In addition, coal is considered to be “dirty” when burned because it can cover an area downwind of a power plant with heavy metals like lead, mercury, radioactive material, and poisons like arsenic. In addition to power generation and heat, coal can also be used to make diesel fuel. But its sulfur content is so high that it isn't commercially viable at this time.

Nuclear power plants are more dangerous than using any other fuels for electric power generation. Spent fuel rods need to be stored on site at many nuclear power plants. In addition, a nuclear disaster can kill hundreds of thousands of people in a very short period of time.

Therefore, a need exists to find energy alternatives, and preferably “clean” and “safe” energy alternatives.

### BRIEF DESCRIPTION OF THE DRAWINGS

FIG. 1 shows top, side, and profile views of an example electric generator.

FIG. 2 is a circuit diagram of an example primary circuit.

FIG. 3a is a circuit diagram of an example “sector” secondary circuit.

FIG. 3b is a circuit diagram of another example “array” secondary circuit.

FIG. 4 is a circuit diagram of an example primary power control switching module.

FIG. 5 shows an example array.

FIG. 5a is an exploded view showing an example sector of the array in FIG. 5.

FIG. 6 shows an example magnet frame.

FIG. 7 shows example end views of the array shown in FIG. 5.

FIG. 8 shows an example element.

FIG. 9 is a circuit diagram of an example collector.

### DETAILED DESCRIPTION

An electric generator is disclosed which can be used as an alternative to fossil fuels. Electric energy is generally considered a “clean” and “safe” energy alternative. The electric generator can be used to supplement or altogether replace the use of oil, natural gas, coal, nuclear energy, and other traditional forms of electric energy generation.

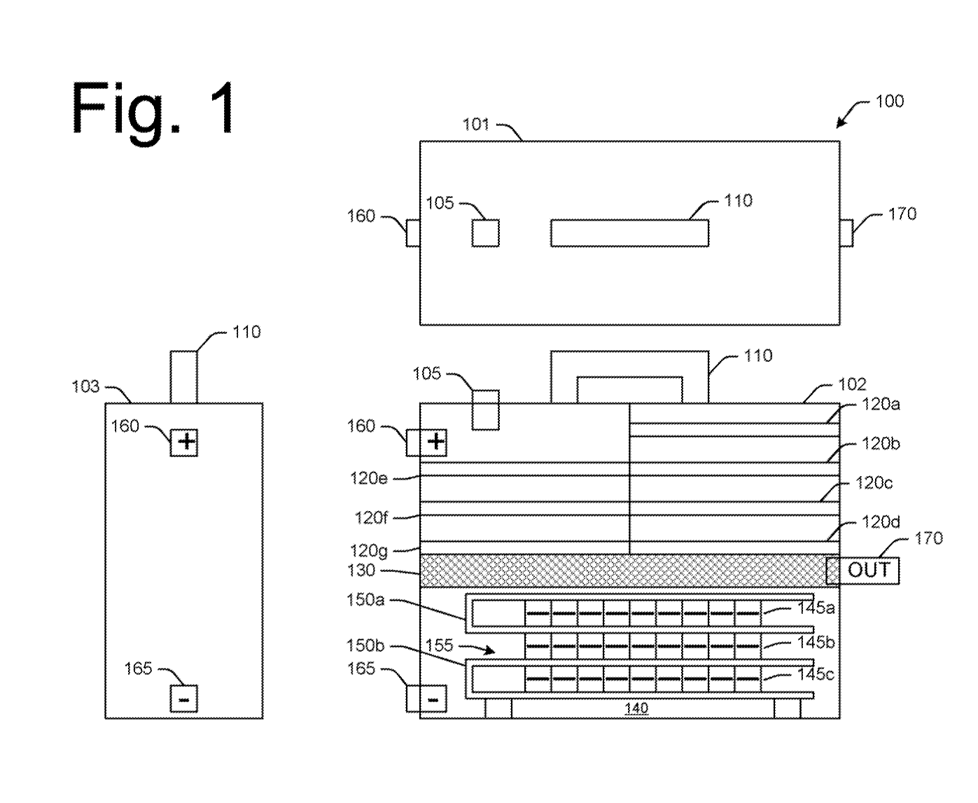

An example of an electric generator disclosed herein has few or even no moving parts. The electric generator is compact in size (e.g., FIG. 1 shows an example generator that is the size of a briefcase), and does not need fossil fuel to operate. The electric generator can be operated for a very long time, and can be used to recharge a battery that is used to start the electric generator. In another example, the electric generator can be implemented without using a battery (e.g., instead using a hand crank connected to a small mechanical generator, a strong electromagnetic field, or an electrical static discharge).

Typical electric generators have mechanical moving parts, which result in frictional losses and lower efficiency. Instead, the electric generator disclosed herein includes coils positioned between electromagnet frame(s). When a solid-state relay is used in place of a coil relay, no moving parts are implemented (other than the primary power control switching module). An example relay switch is rated at one hundred million cycles. When the main relay switch fails, a new relay can be installed just like changing an automobile fuse. When the relay is replaced, the battery may also be replaced. Accordingly, the electric generator can continue to generate electric power on a continuous basis, e.g., for a vehicle, dwelling, and/or other energy consuming purposes.

It is noted that the electric generator may include copper wire. In a basic array, there are 100 magnetic copper wire coils, and so a lot of copper wire is used during manufacture. A large system might require tens of thousands of coils and can be expensive due to the high cost of copper. Accordingly, the electric generator is not limited to use with copper wire coils.

It is also noted that the electric generator may result in the formation of electromagnetic radiation (EMR). EMR emissions can be reduced or even altogether eliminated using a grounded metal casing or other EMR block (e.g., with rubber insulation, shielding, and distance). It is further believed that the electric generator disclosed herein produces far less EMR than the typical utility transformer.

These and other aspects of the electric generator will be realized by those having ordinary skill in the art after becoming familiar with the teachings described herein with reference now to the figures.

FIG. 1 shows top 101, side 102, and profile 103 views of an example electric generator 100. In this example, the electric generator 100 is the size of a typical briefcase, and accordingly includes a handle 110 which may be provided to make the electric generator 100 readily portable. However, the electric generator 100 is not limited to any particular size or other physical configuration.

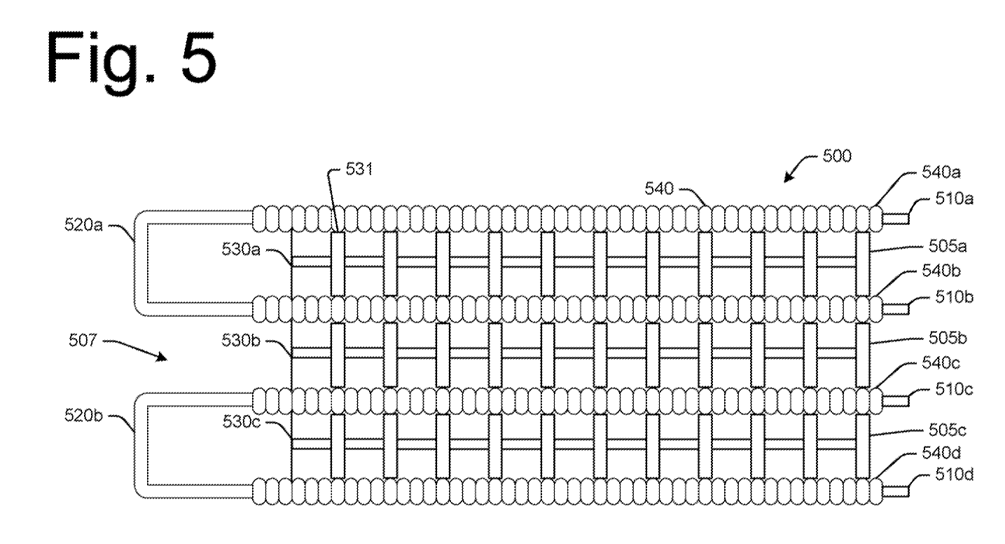

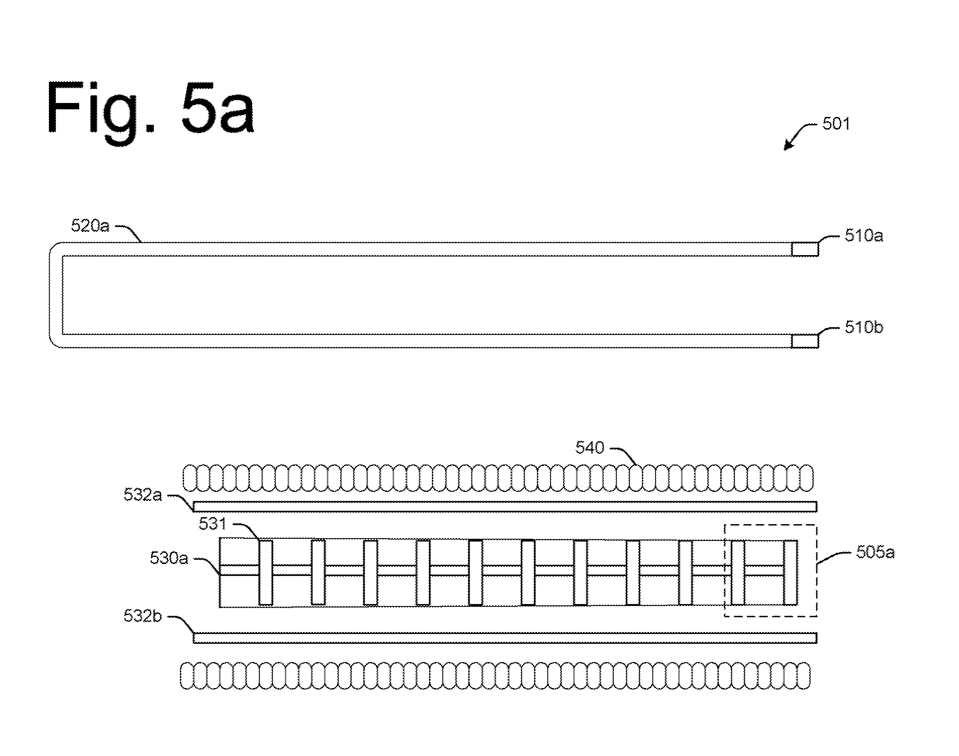

FIG. 1 also shows a number of circuit board(s) 120a-g which may be stacked inside the housing of the electric generator 100, or a separate exterior housing in the case of a high output power electric generator. The circuit boards 120a-g may include the circuitry described below with reference the remaining figures. An area of insulation 130 may also be provided between the circuit boards 120a-g and array generally referred to in FIG. 1 by reference 140. For purposes of clarity, reference 140 is an example of a basic array. The basic array 140 includes three sets of sectors, by reference 145a-c “sandwiched” between two electromagnetic frames by reference 150a-b. Examples of reference 140 are shown in FIGS. 5-8. Electric generator 100 by reference 155 is an example of a “Free Zone” or FZ. No electrical power is consumed during the production of electricity in the FZ. FIG. 1 also shows positive and negative electric terminals 160, 165, respectively, and a power output connections 170.

Again, the electric generator is not limited to any specific combination, number, size, connectors, wires, materials, and/or type of circuit boards, electrical circuits, electronic parts, electromagnetic frames, outer housing, and/or coils. The example shown in FIG. 1 is provided merely for purposes of illustration.

The electric generator, operation has three main areas: Battery (Used to start its process and provide a ground), Primary Circuit, and Secondary Circuit. Secondary circuit can also be sub-divided into alternator/generator array and converter circuits. The electric generator can be made with no moving parts. In another example a low cost relay may be used. A low cost relay with a coil may be used to trigger the alternating action and use much less power.

The electric generator is an alternating/generator that produces a continuous designed power output. In another example, the power output can be made variable to meet any desired voltage and/or current. Total power output is based on the number of elements in use and timer operating rate. By connecting power sensors and a small microprocessor between a load and generator array, the electric generator provides variable output power as needed to any load.

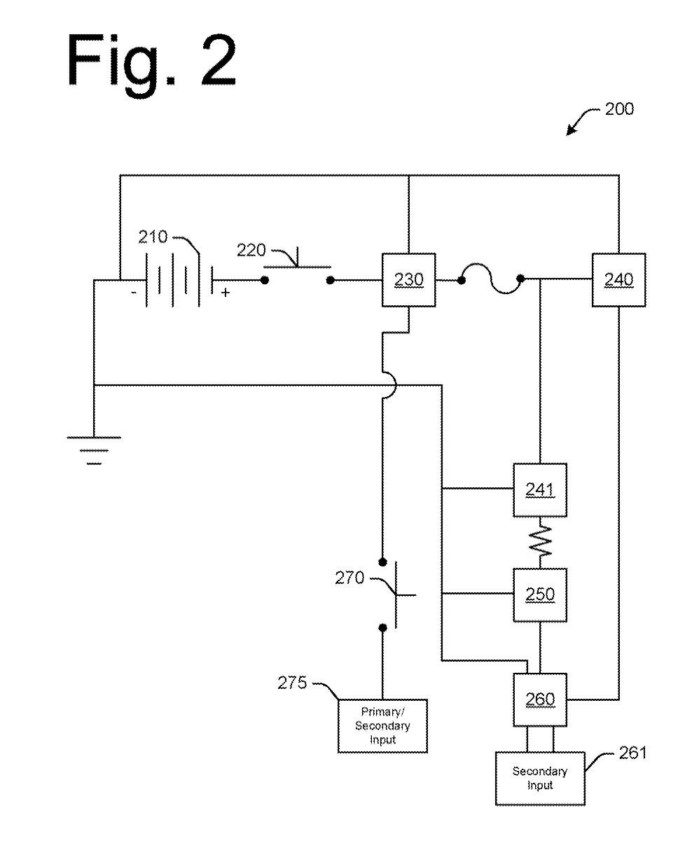

Circuit diagrams, which may be implemented on circuit boards 120 in FIG. 1, are shown in FIGS. 2-4. With reference to these circuit diagrams, it is noted that the term “primary power” as used herein refers to power generated by the electric generator (e.g., and output at power outlet 170 in FIG. 1). The term “secondary power” as used herein refers to power provided from a secondary source, such as a battery, hand crank, etc.

Before continuing, it is also noted that the circuit diagrams shown in FIGS. 2-4 use standard symbols for circuit diagrams, and therefore are not described in detail herein. It is noted that the circuit diagrams are not limited to particular components or size thereof. Indeed, even the interconnection of these components may be varied without departing from the scope of the electric generator described herein. The particular types of components, substitutions thereof, sizing, and arrangement of components will be readily understood by one having ordinary skill in the art after becoming familiar with the teachings herein.

FIG. 2 is a circuit diagram of an example primary circuit 200. The primary circuit 200 may include a battery 210 (or batteries or other start-up mechanism). A switch 220 may be used to take the battery 210 into the circuit during start-up, and primary power control switching module 230 removes battery 210 and switch 220 from the circuit once the electric generator 100 is operating. It is noted that the electric generator 100 may be operated to recharge the battery 210 during operation.

Primary circuit 200 may also include voltage regulators 240, 241 (e.g., 1 amp), a timer 250, and a relay 260 (e.g., a SPDT relay) to the secondary input 261. Another switch 270 may be provided between the primary circuit 200 and the primary/secondary input 275.

In an example, the electric generator is powered by a single rechargeable 12 Volt DC battery. The battery is only used to start the electric generator and provide a ground when no ground is easily available to connect (e.g., grounding rods, metal pipes, etc.).

In an example, a single dual action push button switch 105 (e.g., 105 shown in FIG. 1 and 220, 270 shown in FIG. 2), or a dual action keyed switch is used to activate the electric generator. This switch may also be used to interrupt the primary/secondary power input circuit.

The voltage regulator 241 provides a constant input power to a timer circuit 250. In an example, a timer circuit 250 is used to activate the control post on a Single Post Double Throw (SPDT) relay 260.

The voltage regulator 240 provides constant input power to a common post on a SPDT relay 260.

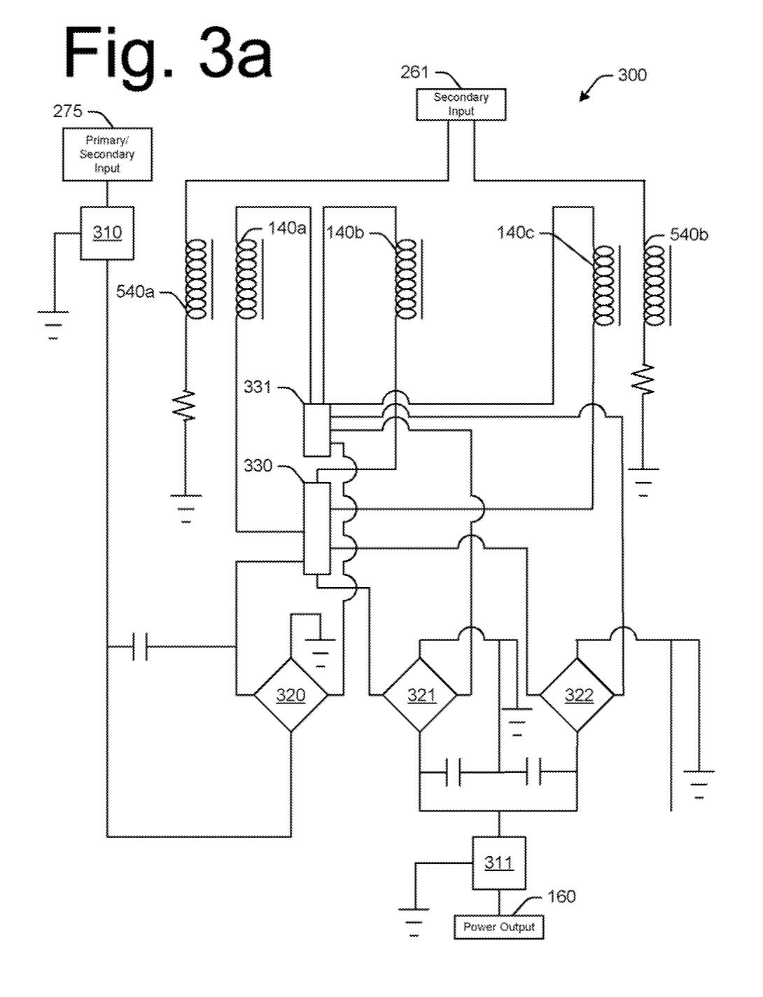

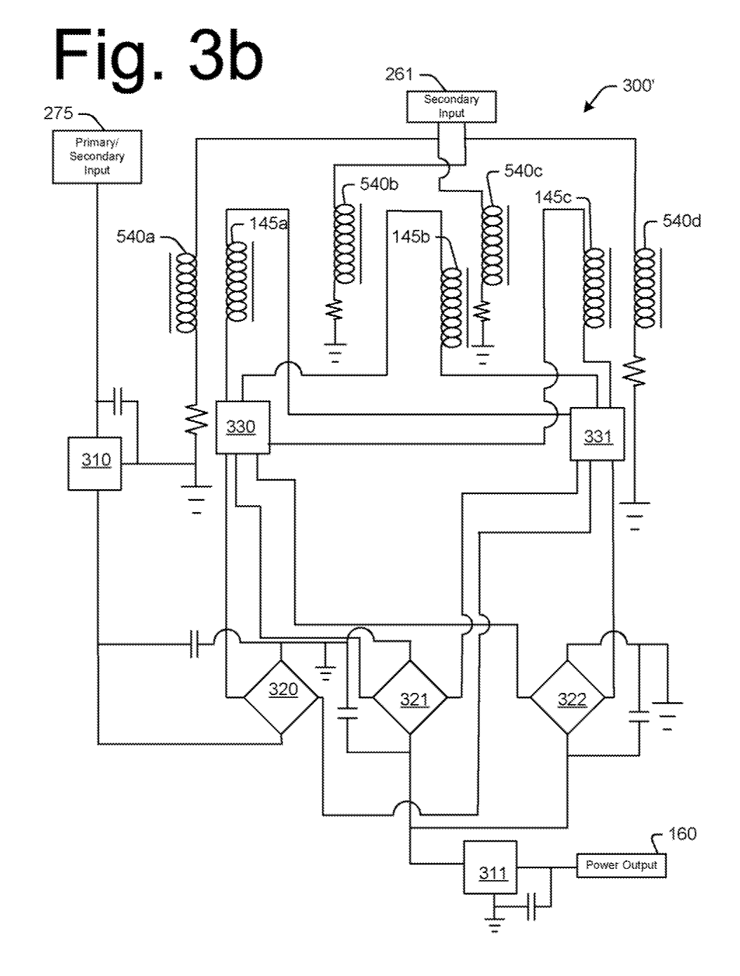

When relay 260 (e.g., circuit diagram 200) is activated by timer 250, voltage and current flow creates an alternating electromagnetic field in the secondary circuit by means of primary secondary connection 261 by reference to FIGS. 3a-b). Without this rely, the electric generator may not operate properly. This relay has a limited useful life, and this relay may need replacing when it fails. This relay may fail more often than any part, but a final manufactured product can set this relay up similar to a fuse-like connection. For example, as an open relay door, pull relay out of socket, place new relay in socket, close relay door, and push “ON” button or turn keyed switch to “ON.”

When the electric generator 100 is activated, power flows directly through the NC terminal on this relay 260. The timer activates at its designated time, and the NO terminal closes long enough for power to flow in the opposite direction. This open and dosing action repeats itself in an alternating fashion, and this action enables the electric generator's 100 ability generate power without an armature, brushes, or any major moving parts.

If a lower ampere electric generator is desired, a single SPDT relay can be used in this circuit. But higher ampere electric generators may need an additional two SPST relays in this circuit to maintain higher cycle rates and current.

FIG. 3a is a circuit diagram of an example “Single Sector” secondary circuit 300. Secondary circuit input power may be connected via 261. Primary input power from secondary may be connected to primary circuit via connection 275. Circuit diagram 300 is shown including a voltage regulator 310-311, bridge rectifiers 320-322 and collectors 330-331. Coil(s) 140a-c may be placed between electromagnetic frame coils 540a-b and power output 160 are also illustrated in the example secondary circuit 300.

The converter circuit 300 includes a minimum of three Bridge Rectifiers (BR) and each Bridge Rectifier converts “X” number of signals from “X” number of coil leads. Two (basic) or more BR's are dedicated toward total power output, and this power output goes to a voltage and current regulator. One BR is dedicated toward providing power to the Primary/Secondary Power Input. This single BR power goes to a voltage and current regulator, and directs power to the Primary Power Control Switching Module. Battery input power is cut off from primary circuit, and this BR is supplying all of the electric generator's primary input power requirements.

FIG. 3b is a circuit diagram of another example secondary circuit 300′. It is noted that like components are illustrated using prime-series (') references and are not explained again herein.

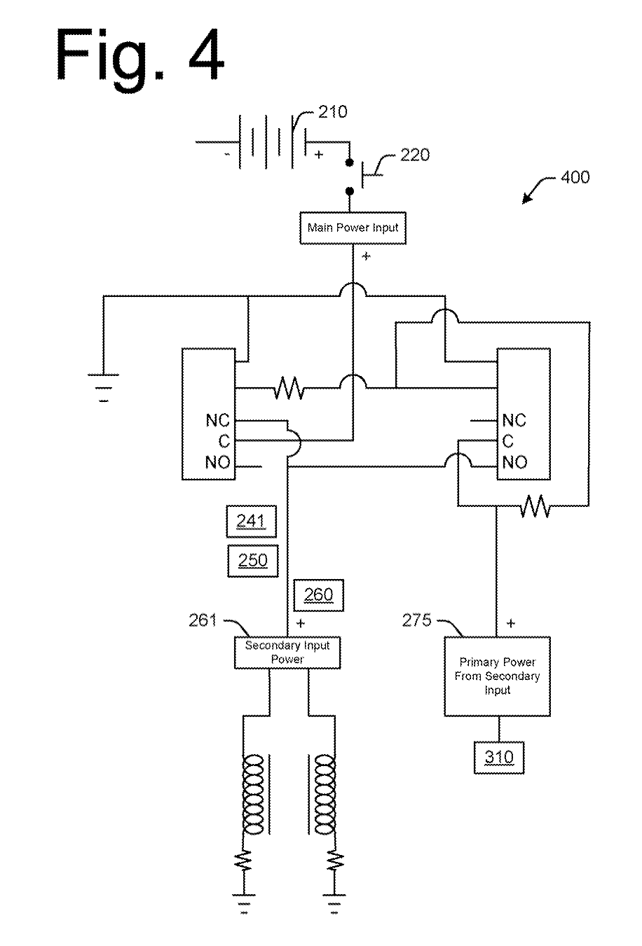

FIG. 4 is a circuit diagram of an example primary power control switching module 400. For example, the primary power control switching module 400 may be implemented as the primary power switch control 230 shown in FIG. 2.

In the example shown in FIG. 4, the primary power control switching module 400 includes two relays (e.g., SPDT relays) connected between the main power 210, secondary power 261, and primary power 275.

The primary power switch control 230 disconnects battery 210 from the primary circuit once secondary circuit is producing a correct output voltage and current to properly power primary circuit. If this switch does not disconnect battery from primary circuit, the battery may be drained of all power within a few days or damaged from over charging battery. The primary power control switching control may be used with a battery charging circuit.

FIG. 5 shows an example array 500. FIG. 5a is an exploded view showing an example sector 530a and with an electromagnetic frame 520a of array 500. Array 500 includes a plurality of sectors 530a-c that are formulated from a plurality of elements 505a-c. Array 500 includes a plurality of electromagnetic frames (or “mag frames”) 520a-b and a plurality of mag frame coils 540a-d. A plurality of non-conductive spacers and dividers 531 are used in array example 500.

Coils 540 are formed on legs 510a-b and 510c-d of each mag frame 520a and 520b. Coils 530a-c are positioned substantially parallel to the legs 510a-b and 510c-d, and a plurality of spacers (e.g., spacer 531) substantially perpendicular to the coils 530a-c are provided to maintain a spaced-apart relation between the individual windings of the each element 505a-c. Spacers 532a-b (see FIG. 5a) are also provided between the elements (e.g., elements 505a) and the legs (e.g., legs 510a-b). The array 500 may include a free zone 507 is formed between mag frames 520a and 520b.

It is noted that while only two mag frames are shown in FIG. 5 comprising the array 500 for purposes of illustration, any number of mag frames may be used in the electric generator 100. In an example, one element is one or two magnetic copper wire coils around a metal core, and there is a spacer made of non-metallic material between each coil. One sector is a plurality of elements positioned between an alternating electromagnetic field (mag frame coils), and thin non-metallic spacers and dividers separate all elements. In the example 500, one array is a number of sectors (e.g., minimum of three sectors in this example) combined together in such a way that all sectors are positioned between two or more alternating electromagnetic fields. It is noted that an array is not limited to any specific number of elements, sectors, shapes, sizes, combinations, and/or arrangements of the mag frames and sectors.

In a further example shown by 500, both inner and outer alternating electromagnetic frame coils 540a-b and 540c-d use power for creation of polarized magnetic fields surrounding sectors 530a-c. The inner sector 530b is positioned between two mag frame coils 540b-c. By virtue of the location 530b between these two alternating magnetic fields 507, sector 530b may produce power without consuming power. This area is referred to herein as the “Free Zone” (FZ) 507 because all power output coming from FZ 507 is literately free power. An example FZ 507 may be half the size of an alternating magnetic field generated by a single sector electromagnet, so an area between two alternating electromagnets may be large enough and strong enough to place many additional sectors 530 within FZ 507. Increasing current through electromagnet frame coils can generate a stronger and larger magnetic field. A minimum of one third of the output power may come from the FZ 507 in an example. Also, it should be noted that an array is not limited any specific number of sectors, shapes, sizes, combinations, and/or arrangements of the sectors and mag frames for use in creating FZ's for use with the electric generator. Example FZ 507, by adding a third electromagnetic frame and two sectors to FIG. 5, array 500 may have an additional FZ 507. At this point, there may be three sectors that consume power for the generation of electric, and a minimum of two FZ sectors that produce power without consumption of any power. If electromagnetic fields around both FZ's are strong enough, then two more sectors may be added to the FZ. At that time, the FZ may maintain a total of four sectors that produce power, while only three sectors consume power. It is noted that when more than two electromagnetic frames are arranged within an array 500, this is called “Array Stacking” or “Stacking.”

Since the electric generator uses a large number of elements to produce power, a number of these elements are dedicated toward producing voltage and current for the electric generator's primary circuit. Once this correct voltage and current makes contact with the primary power control switching module the battery is disconnected from the primary circuit by means of this switching circuit. At this time, the electric generator operates under its own power until primary and secondary circuits are interrupted with a push button SPDT switch or keyed SPDT switch.

In a typical armature-based generator, each sector produces one wave signal at a time and operates at 60 Hz. In contrast, an example array 500 for the electric generator 100 may produce about 96 wave signals at the same time, and may operate at rates close to the speed of light.

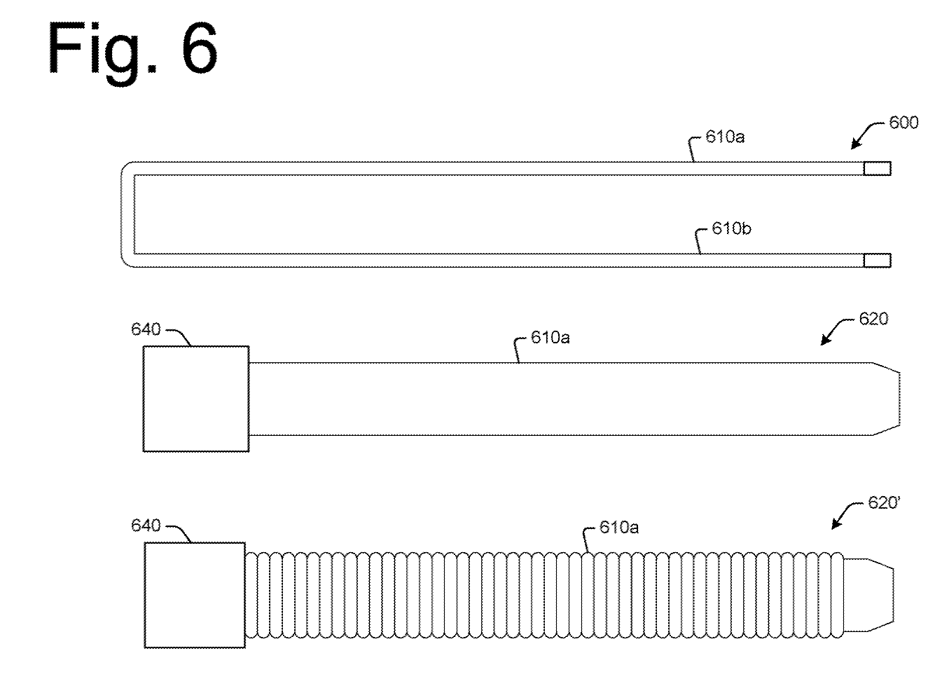

FIG. 6 shows an example mag frame 600 (e.g., the magnet frame 520a shown in FIG. 5). Mag frame 600 may include legs 610a-b.

In the example shown in FIG. 6, a steel mag frame 600 is cut, welded, and grounded according to design specifications. The electric generator 100 normally operates under low ampere conditions, so the frame legs 610a-b may be only one inch apart. The mag frame 600 itself can be made out of iron, soft iron, and/or any material that enables the formation of a good magnetic field, and made longer, wider, and higher to accommodate more elements. The example mag frame size was selected so that the electric generator 100 can be the size of a briefcase. Stacking mag frames and sectors may be implemented as a means of substantially increasing power output without increasing exterior cabinet dimensions.

A magnified view of a portion of one of the legs 610a is shown by reference 620. It can be seen in going from reference 620 to 620′, that coils 630 are designed to slip over the frame legs 610a-b and abut head portion 630. Accordingly, the size of individual coils 610a may be determined by the size of the frame leg 610a.

In an example shown in FIGS. 3a-b, mag frame coils may have resistor(s) between the mag frame coils and ground to slow current flow slightly to enhance the formation of an electromagnetic field. In high current applications, a 1:1 transformer may be connected between the coil and ground to capture some current that would normally flow freely to ground with only minimal resistance. Transformed current can be used anyplace within the electric generator or another external application like headlights on an electric vehicle.

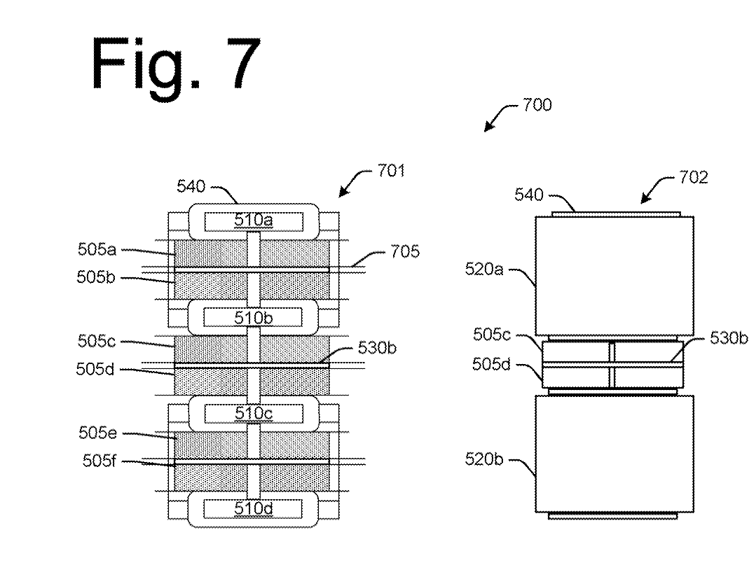

FIG. 7 shows an example array 700, wherein 701 refers to a first end view (e.g., looking from the right hand side of the page in FIG. 5), and 702 refers to a second end view (e.g., looking from the left hand side of the page in FIG. 5). Wire leads can also be seen in FIG. 7 (e.g., as illustrated by reference 705). The remaining reference numbers used in FIG. 7 correspond to FIG. 5 so that the components can be readily identified. Therefore, these components may not be described again with respect to FIG. 7.

In an example, the coil elements 505a-b may include one or two magnetic copper wire coils with metal core (e.g., steel, iron, soft iron, or any core material that will enhance the output power of each element). Non-metallic spacers and dividers separate each coil.

One sector is a number of elements (e.g., element 505a) placed between an alternating electro magnet (e.g., legs 510a-b), and all elements are separated by thin non-metallic dividers (e.g., spacer 532a-b in FIG. 5a). The elements can be placed in a case to keep these secured inside of the frame.

One array 700 is a number of sectors combined together between two or more alternating electro magnetic fields. Both inner and outer alternating electro magnets use power to create magnetic field, but all sectors located within a central zone between these two electro magnetic fields to produce power without consuming any power. This inner area is referred to herein as the “Free Zone (FZ)” because all power output coming from FZ is literately free power. FZ is half the size of an alternating magnetic field generated by a single sector, so a FZ between two alternating electro magnets can be large enough to place many sectors in a strong magnetic field. A stronger magnetic field can be generated by increasing current through electromagnet frame coils and increasing coil wire diameter.

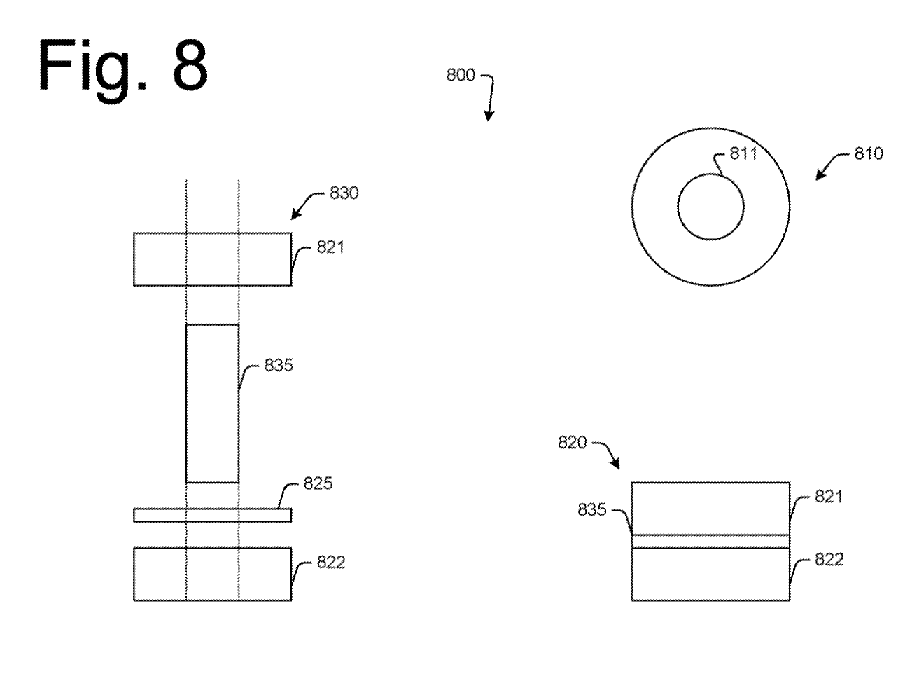

FIG. 8 shows an example element 800 (e.g., the elements 505a-c shown in FIG. 5). Reference 810 shows a top view of the element 800 with the opening 811 formed therethrough. Reference 820 shows a side view of an assembled element, with coils 821 and 822, and a spacer 825. These same elements can be seen in the exploded view 830, in addition to the core 835.

In an example, the opening 811 has a diameter of 0.25 inches, and each coil 821 and 822 has a thickness or height of 0.375 inches and outer diameter of 0.60 inches. The spacer 825 has a thickness or height of 0.10 inches. The core 835 is 0.85 inches tall, and has an outer diameter configured to fit snuggly within the opening 811. Of course other sizes and dimensions are also contemplated.

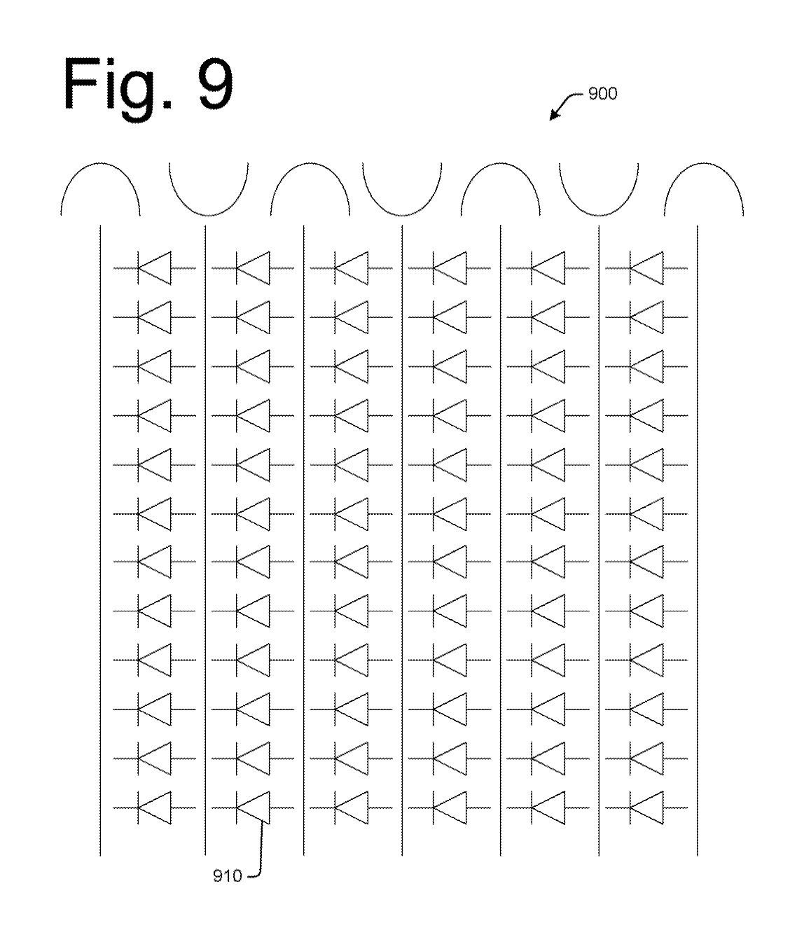

FIG. 9 is a circuit diagram of an example collector 900. In this example, the collector 900 includes a plurality of diodes (e.g., diode 910).

The collector captures the AC signal (wave) coming out of each element coil, and it uses a diode to prevent the signal from retuning to the coils. Each coil lead is then connected in series (or parallel) to increase power output. Since signals may be drawn into any coil along this series, diodes are aligned between each coil lead. All signals are forced toward the converter circuit. In a basic electric generator array there may be 192 coil leads that is connected to the collector.

It is noted that this large number of wire connections may not be practical during large-scale manufacturing and assembly. If this is the case, a sector element/collector frame can be used instead. This frame may replace coil spacers and coil dividers while providing a simple connection for all element leads. Each sector frame then has two main connections between collector and convert circuits.

It should be noted that increasing power output is not limited to a single way of increasing electric generator 100 output 160 power. For example, stacking an array with additional mag frames and sectors, adding sectors to the FZ, increasing current to the mag frame coils, increasing timer cycle rate (e.g., a timer operating at 60 Hz has an output of power “X” and increasing the timer rate to 120 Hz substantially increases power output), and there are other ways of increasing output power, which may even be implemented without a major physical change to the electric generator.

It should be noted that the electric generator described herein is for DC output. But the electric generator may also be used for AC output. For example, removing the bridge rectifier, installing a 120V voltage regulator, and setting the timer at 60 Hz could readily convert a DC generator to an AC generator. For example, by adding a second array, the electric generator 100 can produce 240 VAC, three arrays for 360 VAC, four arrays for 480 VAC, etc. DC power output can also be adjusted, for example, to 12 V, 24 V, 36V, 48 V, etc.

Whether the electric generator is built to produce AC or DC, Ampere and Voltage can be adjusted by means of placing collectors in series or parallel circuits.

It should also be noted that the main relay 260 acts like a commutator, and a switch typically causes a square wave output. The main relay is not connected directly to the sectors, so the wave form has a more natural parabolic shape as power flows through the electromagnet frames coils. When power flows through one mag coil, that side of the mag frame is positively charged, and the opposite side is automatically negatively charged (because it is connected to ground). When the switch is activated, power stops flowing. This is also referred to as the “commutator effect,” and for a few milliseconds, both sides of the mag frame become neutrally charged and grounded. The mag frame may be neutral, but the metal cores in the copper coils may cause a steady decline of power output from the coils. At this time, power can be applied to the other side of the mag frame to cause an increase in power output in the opposite direction.

This alternating action and effect continues until the electric generator is turned off, e.g., by grounding both the primary and primary/secondary return power, or the main alternating switch fails. In an example, the electric generator cannot be turned off by disconnecting just primary power or battery.

Without voltage regulators, the electric generator power output may increase until wires and/or electronic components overloaded and fail. Heat generation is typically not a big issue, because the electric generator normally operates using low amperages on the primary side. But heat might become a factor on the secondary side. For example, a 125 KW power output for EV or 100 A output for a dwelling may need to be implemented with heat sinks and cooling fans to control excess heat. But a basic electric generator with one or a few arrays typically does not need heat controls.

It is also noted that the electric generator is very small and very portable. In an example, the electric generator may be so small that the electric generator can readily be encased within metal shielding as protection from EMP radiation.

In addition, the electric generator may be extremely quiet, because in an example, the only moving part is the main relay 260. The electric generator may also be used to produce more power than it uses. A single 12V battery or a small hand cranked generator can be used to start the electric generator under most conditions. A large electric generator system (e.g., to power a town) may need a bank of batteries.

It is noted that electronic components may include any of a wide variety of commercially available or specifically manufactured components The electronic components may be sized and connected in any suitable manner based on various design considerations. Specific circuitry shown and described herein is provided to illustrate exemplary implementations. It is noted that the circuitry is not limited to the circuit diagrams shown. Still other circuitry and/or components may also be implemented.

It is also noted that the exemplary embodiments shown and described are provided for purposes of illustration and are not intended to be limiting. Still other embodiments are also contemplated.

1. An electric generator, comprising:
a temporary energy source for starting operations;
a primary circuit to disconnect the temporary energy source after starting operations; and
a secondary circuit including an array, a collector, and a converter, the collector to collect an AC signal from the array and the converter to convert the AC signal into electric power for output by the electric generator.

2. The electric generator of claim 1 further comprising a charging circuit to recharge the temporary energy source.

3. The electric generator of claim 1 further comprising no moving parts.

4. The electric generator of claim 1 wherein total output power is directly proportional to a number of elements in the array, timer cycle rate, relay cycle rate, and increase in current.

5. The electric generator of claim 1 wherein each element of the array includes at least one magnetic coil on a metal core and a non-metallic spacer between each coil.

6. The electric generator of claim 1 further comprising a plurality of sectors each comprising a plurality of elements positioned between alternating electromagnets.

7. The electric generator of claim 6 wherein the plurality of elements are separated by non-metallic dividers.

8. The electric generator of claim 1 wherein each array is a plurality of sectors combined between two or more alternating electromagnetic fields.

9. The electric generator of claim 1 further comprising a free zone formed between two alternating electromagnetic fields, the free zone producing power without consuming power.

10. The electric generator of claim 9, wherein the free zone is half the size of an alternating magnetic field generated by a single sector electromagnet.

11. The electric generator of claim 10, wherein the free zone is sized to accommodate a plurality of sectors in a magnetic field.

12. The electric generator of claim 11, wherein the magnetic field is generated by increasing current through electromagnetic frame coils.

13. The electric generator of claim 9, wherein at least one-third of power output by the electric generator is from the free zone.

14. The electric generator of claim 1 wherein power is generated until operation is interrupted by a switch.

15. An electric generator with no moving parts, comprising:
an array of a plurality of sectors each comprising a plurality of elements positioned between alternating electromagnets and separated by non-metallic dividers;
a collector to collect a power signal from the array; and
a converter to convert the power signal into electric power for output by the electric generator.

16. The electric generator of claim 15 wherein each element of the array includes at least one magnetic coil on a metal core and a non-metallic spacer between each coil.

17. The electric generator of claim 15 wherein each array is a plurality of sectors combined between two or more alternating electromagnetic fields.

18. An electric generator with no moving parts, comprising:
an array of a plurality of sectors each comprising a plurality of elements positioned between alternating electromagnets and separated by non-metallic dividers;
a collector to collect a power signal from the array;
a converter to convert the power signal into electric power for output by the electric generator; and
a free zone formed between two alternating electromagnetic fields, the free zone producing power without consuming power.

19. The electric generator of claim 18, wherein the free zone sized to accommodate a plurality of sectors in a magnetic field, and the free zone is half the size of an alternating magnetic field generated by a single sector electromagnet by increasing current through electromagnetic frame coils.

20. The electric generator of claim 18, wherein at least one-third of power output by the electric generator is from the free zone.
